(19) United States
(12) Patent Application Publication
(10) Pub. No.: US 2024/0035679 A1
(43) Pub. Date: Feb. 1, 2024

(54) LABORATORY

(71) Applicant: ATLATL (Shanghai) Technology Co., Ltd., Shanghai City (CN)

(72) Inventor: PengCheng ZHU, Shanghai City (CN)

(73) Assignee: ATLATL (Shanghai) Technology Co., Ltd., Shanghai City (CN)

(21) Appl. No.: 18/276,130

(22) PCT Filed: Jan. 20, 2022
(86) PCT No.: PCT/CN2022/072891

§ 371 Date: Aug. 7, 2023

(30) Foreign Application Priority Data
Mar. 4, 2021 (CN) 202110240960.5

(51) Int. Cl. F24F 3/167; F24F 7/08

(52) U.S. Cl. CPC F24F 3/167; F24F 7/08; F24F 11/74

(57) ABSTRACT

Disclosed is a laboratory. The laboratory comprises a plurality of laboratory units. Each laboratory unit comprises a first region and a second region. The first region comprises: a first air supply connection pipeline, wherein one end of the first air supply connection pipeline is in communication with an air supply main pipeline, the other end of the first air supply connection pipeline forms a first air supply port, and the first air supply connection pipeline is internally provided with a first air supply valve; and a first air exhaust connection pipeline, wherein one end of the first air exhaust connection pipeline is in communication with an air exhaust main pipeline, the other end of the first air exhaust connection pipeline forms a first air exhaust port, and the first air exhaust connection pipeline is internally provided with a first air exhaust valve. The second region comprises: a second air supply connection pipeline, wherein one end of the second air supply connection pipeline is in communication with the air supply main pipeline, the other end of the second air supply connection pipeline forms a second air supply port, and the second air supply connection pipeline is internally provided with a second air supply valve; and a second air exhaust connection pipeline, wherein one end of the second air exhaust connection pipeline is connected to the air exhaust main pipeline, the other end of the second air exhaust connection pipeline forms a second air exhaust port, and the second air exhaust connection pipeline is internally provided with a second air exhaust valve. The air exhaust and supply valves in each region can be adjusted as needed so as to make each laboratory unit meet gas environment requirements such as the required pressure conditions.

### CROSS-REFERENCE TO RELATED APPLICATIONS

This application claims priority to PCT Application No. PCT/CN2022/072891 filed on Jan. 20, 2022, which claims priority to Chinese Patent Application No. 202110240960.5, filed on Mar. 4, 2021, both of which are incorporated herein by reference in their entireties.

### TECHNICAL FIELD

The invention relates to the technical field of experiments, in particular to a laboratory.

### BACKGROUND OF THE DISCLOSURE

The laboratory is not only a place for experiments, but also the cradle of science, the base of scientific research and the source of scientific and technological development, which plays a very important role in the development of science and technology. Because the laboratory needs to carry out various reaction experiments, these reaction experiments may generate substances that are toxic to the human body, and some substances are easily scattered into the air to pollute the air in the laboratory, so the laboratory is usually equipped with a ventilation system. The so-called ventilation is to discharge the dirty air in the laboratory directly or after purification to the outside, and replenish fresh air, so as to maintain the indoor air conditions and keep the laboratory to meet the requirements of the experiment.

In actual operation, due to the requirements of different experiments, different experimental areas may require different pressure conditions (such as negative pressure or positive pressure). However, the space of the current laboratory is not variable, and the pressure conditions in the laboratory are also invariable. (either a negative pressure laboratory or a positive pressure laboratory), which is not conducive to the recycling of the laboratory.

### SUMMARY

The purpose of the present invention is to solve the technical problems of invariable laboratory pressure and invariable space in the prior art.

In order to solve the above technical problem, an embodiment of the present invention discloses a laboratory, comprising: including a plurality of laboratory units, each laboratory unit including a first area and a second area; wherein, the first area includes: the first air supply connection pipe has one end connected to the main air supply pipe, and the other end forms a first air supply port that communicates with the gas environment of the first area, and the first air supply connection pipe is provided with a first air supply valve; the first exhaust connection pipe has one end connected to the main exhaust pipe, and the other end forms a first exhaust port that communicates with the gas environment of the first area, and the first exhaust connection pipe is provided with a first exhaust valve; the second area includes: the second air supply connection pipe has one end connected to the main air supply pipe, and the other end forms a second air supply port that communicates with the gas environment in the second area, and a second air supply valve is arranged in the second air supply connection pipe; one end of the second exhaust air connection pipe is connected to the exhaust air main pipe, and the other end forms a second air exhaust port that communicates with the gas environment of the second area. The second air exhaust connection pipe is provided with a second air exhaust valve.

Optionally, the laboratory provided in the embodiment of the present invention further includes a plurality of experimental areas, and each experimental area is formed by splicing at least one laboratory unit.

Optionally, in the laboratory provided by the embodiment of the present invention, each laboratory unit further includes an air supply branch pipe and an air exhaust branch pipe; wherein,

The first air supply connection pipe and the second air supply connection pipe are both connected to the air supply branch pipe, and are connected to the air supply main pipe through the air supply branch pipe, and the air supply branch pipe is provided with a recooling coil and/or reheating Coiled pipe, used to adjust the temperature of the gas in the air supply branch pipe; and the first air exhaust connection pipe and the second air exhaust connection pipe are both connected with the exhaust branch pipe and are connected with the exhaust main pipe through the exhaust branch pipe.

Optionally, in the laboratory provided by the embodiment of the present invention, the ratio of the fresh air volume in the first area to the volume of the first area is greater than or equal to 12; the fresh air volume in the second area and the volume of the second area are greater than or equal to 12; and the ratio is greater than or equal to 12.

Optionally, in the laboratory provided by the embodiment of the present invention, the first air supply connection pipeline, the first exhaust air connection pipeline, the second air supply connection pipeline, the second exhaust air connection pipeline, the air supply branch pipeline, and the exhaust air connection pipeline and the wind speed in the branch pipe is 3-5 m/s.

Optionally, in the laboratory provided by the embodiment of the present invention, the first air supply connection pipeline includes a first air supply inlet straight pipeline connected to the inlet end of the first air supply valve and a first air supply inlet straight pipeline connected to the outlet end of the first air supply valve. Air supply outlet straight pipe; wherein, the diameter of the first air supply inlet straight pipe is 1.5 times the width of the first air supply valve, and the diameter of the first air supply outlet straight pipe is 0.5 times the width of the first air supply valve;

The first exhaust air connection pipeline includes a first exhaust air inlet straight pipeline connected to the inlet end of the first exhaust valve and a first exhaust air outlet straight pipeline connected to the outlet end of the first exhaust valve; wherein, the first exhaust air inlet straight pipeline The diameter of the first exhaust valve is 1.5 times the width of the first exhaust valve, and the diameter of the straight pipe of the first exhaust outlet is 0.5 times the width of the first exhaust valve.

Optionally, in the laboratory provided by the embodiment of the present invention, the second air supply connection pipeline includes a second air supply inlet straight pipeline connected to the inlet end of the second air supply valve and a second air supply inlet end connected to the outlet end of the second air supply valve. Air supply outlet straight pipe; wherein, the diameter of the second air inlet straight pipe is 1.5 times the width of the second air supply valve, and the diameter of the second air outlet straight pipe is 0.5 times the width of the second air supply valve;

The second exhaust connection pipeline includes a second exhaust inlet straight pipeline connected to the inlet end of the second exhaust valve and a second exhaust outlet straight pipeline connected to the outlet end of the second exhaust valve; wherein the second exhaust inlet straight pipeline The diameter of the second exhaust valve is 1.5 times the width of the second exhaust valve, and the diameter of the second exhaust outlet straight pipe is 0.5 times the width of the second exhaust valve.

Optionally, in the laboratory provided by the embodiment of the present invention, the distance between each adjacent air valve is at least 0.5 meters.

Optionally, in the laboratory provided by the embodiment of the present invention, the first air supply valve and/or the second air supply valve is a constant air volume valve; and/or, the first air exhaust valve and/or the second air exhaust valve For the variable air volume valve.

Optionally, in the laboratory provided by the embodiment of the present invention, the length of the first area is 5.05 m, the width is 3.3 m, and the height is 2.84 m; the length of the second area is 2.95 m, the width is 3.3 m, and the height is 2.84 m.

Optionally, in the laboratory provided by the embodiment of the present invention, the first area is a laboratory operation room, and the second area is a buffer room.

Compared with the prior art, the present invention has the following technical effects:

By dividing the laboratory into a plurality of laboratory units, each laboratory unit can be subdivided into a first area and a second area, and each first area and second area are independently provided with air supply valves and exhaust air Therefore, the exhaust valve and air supply valve in each area can be adjusted according to the gas pressure environment required by each area to control the air intake and exhaust air volume of each area, so that each laboratory unit can reach its own Gas environment requirements such as required pressure conditions. In addition, since each laboratory unit is connected to the main air intake pipe and the main exhaust air pipe through pipes, it is not necessary to set up an air conditioning system in each laboratory unit, and each laboratory unit only needs to be connected to the same main unit. When the air conditioning system is connected, the gas replacement in each laboratory unit can be realized, which saves the construction cost of the laboratory and also reduces the energy waste.

### BRIEF DESCRIPTION OF DRAWINGS

FIG. 1 is a schematic plan view of a laboratory provided by a specific embodiment of the present invention.

FIG. 2 is a schematic perspective view of a laboratory provided by a specific embodiment of the present invention.

FIG. 3 is a schematic plan view one of a laboratory unit provided by a specific embodiment of the present invention.

FIG. 4 is a second schematic plan view of a laboratory unit provided by a specific embodiment of the present invention.

FIG. 5 is a schematic plan view three of a laboratory unit provided by a specific embodiment of the present invention.

FIG. 6 is a schematic diagram 1 of the assembly of each laboratory unit provided by a specific embodiment of the present invention.

FIG. 7 is the assembly schematic diagram 2 of each laboratory unit provided by a specific embodiment of the present invention.

FIG. 8 is a third assembly schematic diagram of each laboratory unit provided by an embodiment of the present invention.

### DETAILED DESCRIPTION OF EMBODIMENTS

The embodiments of the present invention are described below by specific embodiments, and those skilled in the art can easily understand other advantages and effects of the present invention from the contents disclosed in this specification. Although the description of the invention will be presented in conjunction with the preferred embodiment, this does not mean that the features of the invention are limited to this embodiment. On the contrary, the purpose of introducing the invention in conjunction with the embodiments is to cover other options or modifications that may be extended based on the claims of the invention. The following description will contain numerous specific details in order to provide a thorough understanding of the present invention. The invention may also be practiced without these details. Furthermore, some specific details will be omitted from the description in order to avoid obscuring or obscuring the gist of the present invention. It should be noted that the embodiments of the present invention and the features of the embodiments may be combined with each other under the condition of no conflict.

It should be noted that in this specification, like numerals and letters refer to like items in the following figures, so that once an item is defined in one figure, it need not be used in subsequent figures. Make optional definitions and explanations.

In the description of this embodiment, it should be noted that the orientation or positional relationship indicated by the terms “inside”, “outside”, etc. is based on the orientation or positional relationship shown in the accompanying drawings, or is usually placed when the product of the invention is used. The orientation or positional relationship is only for the convenience of describing the present invention and simplifying the description, rather than indicating or implying that the indicated device or element must have a specific orientation, be constructed and operated in a specific orientation, and therefore should not be construed as a limitation of the present invention.

The terms “first”, “second”, etc. are only used to differentiate the description and should not be construed to indicate or imply relative importance.

In the description of this embodiment, it should also be noted that, unless otherwise expressly specified and limited, the terms “arrangement” and “connection” should be understood in a broad sense, for example, it may be a fixed connection or a detachable connection, Or integrally connected; it can be directly connected or indirectly connected through an intermediate medium; it can be a mechanical connection or an electrical connection. For those of ordinary skill in the art, the specific meanings of the above terms in this embodiment can be understood in specific situations.

In order to make the objectives, technical solutions and advantages of the present invention clearer, the embodiments of the present invention will optionally be described in detail below with reference to the accompanying drawings.

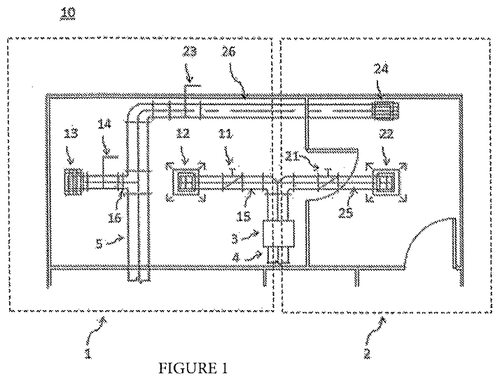

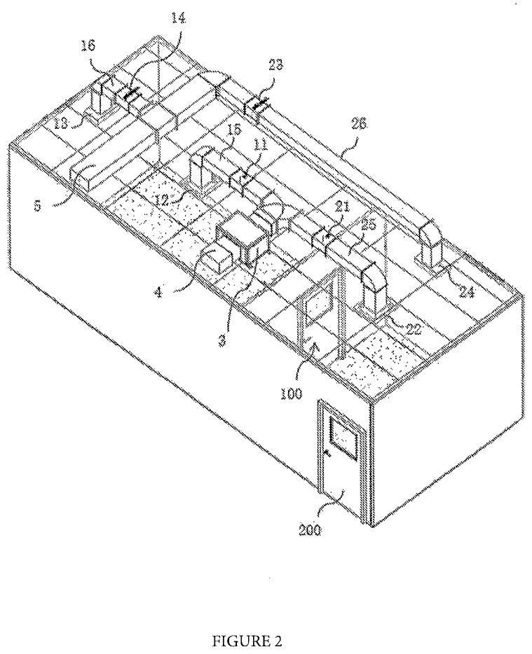

Referring to FIG. 1, the present application provides a laboratory comprising a plurality of laboratory units 10. As shown in FIGS. 1 and 2, according to a laboratory according to a specific embodiment of the present invention, each laboratory unit 10 includes a first area 1 and a second area 2. That is, the laboratory can be constructed by a plurality of laboratory units 10, and the laboratory units 10 can be subdivided into the first area 1 and the second area 2. In the specific implementation, the first area 1 and the second area 2 can be It is separated by a partition to achieve the purpose of isolating the gas environment of the two regions so as to avoid mutual influence.

Specifically, the first area 1 may include a first air supply valve 11, a first air exhaust valve 14, a first air supply connection duct 15 and a first air exhaust connection duct 16. Wherein, one end of the first air supply connection pipe 15 is connected with the main air supply pipe (not shown in the figure), and the other end forms a first air supply port 12 which is communicated with the gas environment of the first area 1; the first exhaust air connection pipe One end of 16 is communicated with the exhaust main pipe (not shown in the figure), and the other end forms a first exhaust port 13 that communicates with the gas environment of the first area 1; the first air supply valve 11 is arranged in the first air supply connection In the pipeline 15, the first exhaust valve 14 is arranged in the first exhaust connection pipeline 16. Specifically, both ends of the first air supply valve 11 are respectively communicated with the first air supply connecting pipe 15, and both ends of the first air exhaust valve 14 are respectively communicated with the first air exhaust connecting pipe 16. The second area 2 may include a second air supply valve 21, a second air exhaust valve 23, a second air supply connection duct 25 and a second air exhaust connection duct 26. One end of the second air supply connection duct 25 is connected to the air supply main duct, and the other end forms a second air supply port 22 that communicates with the gas environment of the second area 2; one end of the second exhaust air connection duct 26 is connected to the air exhaust main duct The other end forms a second air outlet 24 that communicates with the gas environment of the second area 2; the second air supply valve 21 is arranged in the second air supply connection pipe 25, and the second air outlet valve 23 is arranged in the second The exhaust air is connected to the duct 26. Specifically, the two ends of the second air supply valve 21 are respectively communicated with the second air supply connecting pipe 25; the two ends of the second air exhaust valve 23 are respectively communicated with the second air exhaust connecting pipe 26.

In a specific implementation, the main air intake duct can be communicated with an air-conditioning system, and the main exhaust air duct can be communicated with the outdoor atmospheric environment. And the gas environment (such as pressure, air volume, etc.) in each area (i.e., the first area 1 and the second area 2) and even each laboratory unit can be adjusted by adjusting the exhaust valve and air supply valve set in it, so as to Bring each area (or laboratory unit) to its desired gaseous environment. For example, if the first area 1 needs negative pressure and the second area 2 needs positive pressure, you can adjust the air supply volume of the first air supply valve 11 and the air supply volume of the first air exhaust valve 14 in the first area 1 respectively. Exhaust air volume, so that the pressure condition in the first area 1 reaches the set negative pressure value, so that the first area 1 is a negative pressure environment. By adjusting the air supply volume of the second air supply valve 21 and the exhaust air volume of the second air exhaust valve 23 in the second area 2, the pressure condition in the second area 2 can reach the set positive pressure value, so that the first The second area 2 is a positive pressure environment. Specifically, when the air supply volume in a certain area is greater than the exhaust air volume, the area is positive pressure; and when the air supply volume is less than the exhaust air volume, it is negative pressure.

Those skilled in the art should understand that different air valves have different adjustment methods. Some can adjust the expansion and contraction of the airbag according to the pressure, some can adjust the gap between the valve body and the valve wall according to the pressure, and some can also adjust the expansion and contraction of the spring according to the pressure, so the adjustment of the air valve can be carried out with reference to the specific operating instructions of the air valve.

In the present invention, by dividing the laboratory into a plurality of laboratory units 10, each laboratory unit 10 can be subdivided into a first area 1 and a second area 2, and each of the first area 1 and the second area 2 is independently The air supply valve and air exhaust valve are set, so the air exhaust valve and air supply valve in the area can be adjusted according to the gas pressure environment required by each area to control the air intake and exhaust air volume of each area, thereby This enables each laboratory unit 10 to meet gas environment requirements such as respective required pressure conditions. In addition, since each laboratory unit 10 is connected to the main air intake duct and the main exhaust air duct through pipes, it is not necessary to install an air conditioning system in each laboratory unit 10, and each laboratory unit only needs to be connected to the same The air-conditioning system of the main unit is connected, and the gas replacement in each laboratory unit can be realized, which saves the construction cost of the laboratory and reduces the energy waste.

Generally, a laboratory may include an experimental operating room and a buffer room, wherein the buffer room is set between the experimental operating room and the external environment, and its function is to isolate the outside world and the experimental operating room, so as to prevent the outside from interfering with the environment of the experimental operating room. In the present invention, the first area 1 may be an experimental operation room, and the second area 2 may be a buffer room. As shown in FIG. 2, the experimenter can first enter the buffer chamber through the door 200 of the buffer chamber, and then enter the experimental operation room through the door 100 of the experimental operation room to conduct experiments. Of course, in other embodiments, the first region 1 can also be set as a buffer chamber, and the second region 2 can be set as an experimental operation room. Taking the first area 1 as an experimental operation room and the second area 2 as an example of a buffer chamber, in the multiple laboratory units 10 of the laboratory, the first area of the multiple laboratory units can be allowed to communicate as an experimental operation. The chamber, and the second area of multiple laboratory units are connected as a buffer chamber, so as to achieve the purpose of changing the space of the experimental area.

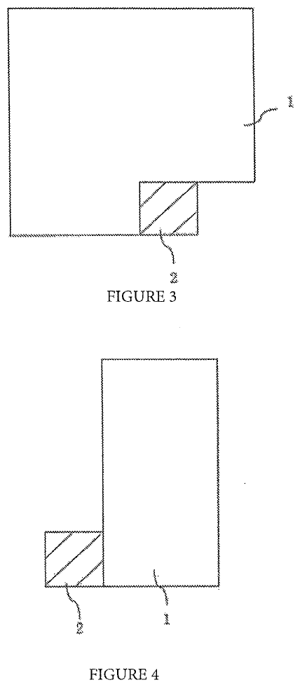

It should be noted that although the first area and the second area shown in FIG. 1 are regular cuboid areas adjacent to each other, their widths and heights are equal. However, the size and shape of the first area (or the second area) of the laboratory unit provided by the present invention are not limited thereto. The length, width, height or shape of the first area and the second area can be set according to actual needs. The size and shape of the first region (or the second region) may vary from laboratory unit to laboratory unit, e.g., as shown in FIGS. 3-5. In the laboratory units shown in FIGS. 3 and 5, the first area 1 is a cuboid structure with a gap, and the second area 2 (shown in the shaded part in the figure) is also a regular cuboid. 2 is arranged in the notch of the first area 1. The difference is that the size of the notch in the second area 2 in FIG. 3 is smaller than that in the first area 1, while the size of the notch in the second area 2 in FIG. 5 is exactly equal to that in the first area 1; Although the second area 2 (shown by the shaded part in the figure) is the same as in FIG. 1, it is a regular cuboid adjacent to each other, but different from that shown in FIG. 1, the lengths of the first area 1 and the second area 2 in FIG. 4 are different. and width are not equal.

Optionally, in a specific embodiment of the present invention, the laboratory may further include multiple experimental areas, and each experimental area may be formed by splicing at least one laboratory unit 10.

That is, one or more laboratory units 10 can be used for splicing and assembling according to the individual needs of the user, so as to form the experimental area required by the user. The size of the experimental area is spliced according to the needs of the user, and the pressure conditions of the experimental area are adjusted according to the needs of the user.

Using the above method, when the user needs a larger area of the experiment area as a laboratory, it can be assembled into an experiment area that meets the user's needs by splicing multiple laboratory units; and when the user needs a smaller experiment area as a laboratory When using the space of the test area, it is also possible to separate the assembled large-area experimental area by the partition, but when using the partition to divide the space of the experimental area, it is necessary to ensure that each separated area has at least one exhaust valve and An air supply valve, so that the user can make the laboratory gas environment meet the experimental requirements by adjusting the air exhaust valve and the air supply valve. Thereby, the recycling of the laboratory is realized, and the problem of having to rebuild the laboratory due to the change of the area required by the user for the laboratory is effectively avoided, that is, the construction cost of the laboratory is effectively reduced.

Specifically, when splicing and assembling the experimental areas, the placement positions of the laboratory units may be different, that is, the first area 1 of one laboratory unit 10 may be adjacent to the second area 2 of the other laboratory unit 10. It can also be that the first area 1 of one laboratory unit 10 is adjacent to the first area 1 of the other laboratory unit 10, either the long side of the first area 1 and the long side of the second area 2 are adjacent the broad side of the first region 1 and may be adjacent to the long side of the second region 2. Not required here.

When the experimental area required by the customer is large, two, three or more laboratory units 10 can be assembled by splicing, and the specific number of laboratory units 10 used for splicing the experimental area can be based on the customer's requirements. The experimental area is determined. When splicing, each laboratory unit can be spliced according to certain rules according to the needs of customers. For example, each laboratory unit can be spliced, a partition is set between the first area and the second area of each laboratory unit, and a partition is also set between each area of different laboratory units, that is, each laboratory unit All exist as an independent laboratory operation room; of course, the first area or the second area of some laboratory units can also be combined to form a larger laboratory operation room. Exemplarily, the following three embodiments are used as examples to specifically describe the different types of splice ng multiple laboratory units into one experimental area. In the following three embodiments, the shapes shown in FIGS. 3 to 5 are used. Laboratory units are spliced, but the type of experimental area is not limited to this.

### Example 1

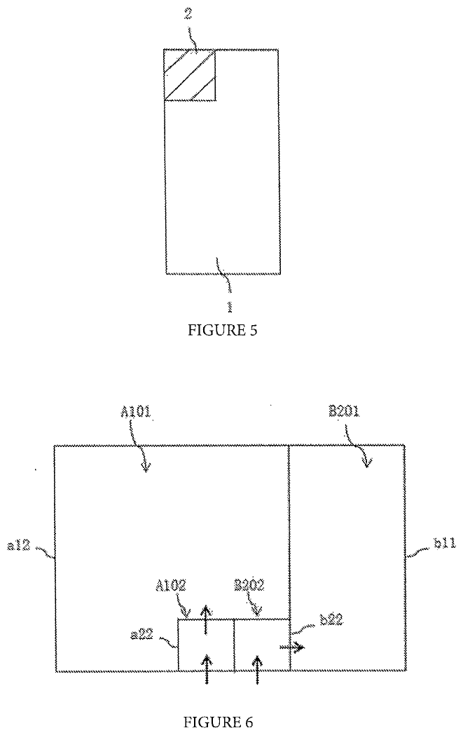

As shown in FIG. 6, the experimental area is formed by splicing two laboratory units, which are denoted as unit A and unit B respectively, and the arrow in the figure is the direction of the experimenter entering the experimental area. Specifically, for the convenience of description, the A unit includes a first area A101 and a second area A102, the B unit includes a first area B201 and a second area B202, and the first area A101 of the A unit and the first area B201 of the B unit are The shape as well as the length and width are different. During splicing, the wide side a22 of the second area A102 of the A unit is adjacent to the wide side b22 of the B unit second area B202, and the wide side a12 of the A unit first area A101 is adjacent to the long side b11 of the B unit first area B101. The first area A101 and the first area B201 are two different experimental operating rooms. During the experiment, the experimenter can enter the first area A101 through the second area A102 of the A unit, and enter the first area through the second area B202 of the B unit. B201. In addition, the first and second areas of each laboratory unit and each area of different laboratory units are isolated by partitions, so as to ensure that the pressure conditions in each area are independent of each other. That is, the air pressure in each area is set by adjusting the air supply valve and the air exhaust valve in each area, so that the experimenter can perform different experiments in the first area A101 and the first area B201 that meet the preset conditions respectively.

### Embodiment 2

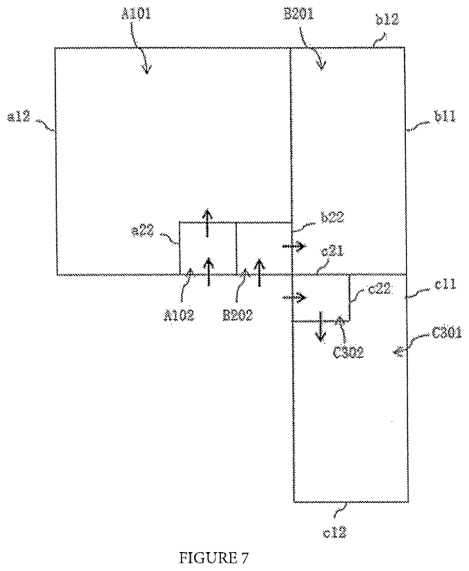

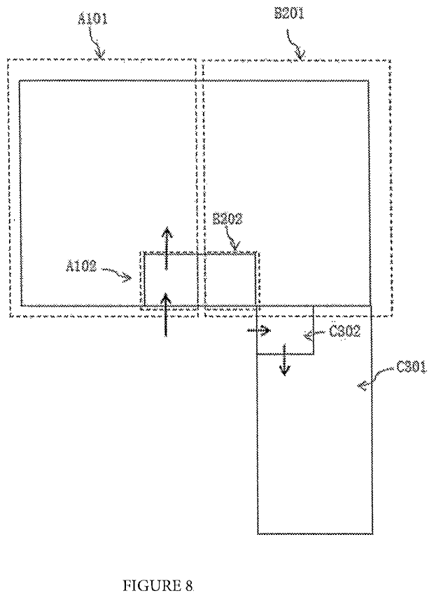

FIG. 7 is a schematic diagram of the assembly of the experimental area provided in another embodiment, the laboratory is assembled by three laboratory units, the three laboratory units are respectively recorded as A unit, B unit and C unit, the arrows in the figure It is the direction for the experimenter to enter the experiment area. Specifically, unit A includes a first area A101 and a second area A102, unit B includes a first area B201 and a second area B202, and unit C includes a first area C301 and a second area C302. During splicing, the broadside a22 of the second area A102 of the A unit is made to be adjacent to the broadside b22 of the second area B202 of the B unit, and the broadside a12 of the first area A101 of the A unit and the broadside of the first area B201 of the B unit The long side b11 is adjacent to each other, the broad side b12 of the first area B201 of the B unit is adjacent to the broad side c12 of the first area C301 of the C unit and the long side c21 of the C unit second area C302, and the second area C302 of the C unit is adjacent. The broad side c22 is adjacent to the long side c11 of the first region C301 of the C unit. The first area A101, the first area B201 and the first area C301 are used as three different experimental operation rooms. During the experiment, the experimenter can enter the first area A101 of the unit A through the second area A102 of the unit A, and pass the unit B. The second area B202 enters the first area B201 of the B unit, and enters the first area C301 of the C unit through the second area C302 of the C unit. And the first and second areas of each laboratory unit and each area of different laboratory units are isolated by partitions, and the air supply valve and air exhaust valve of each area are adjusted respectively to set the air flow in each area. pressure, so that the experimenter can perform different experimental operations respectively in the first area A101, the first area B201 or the third area C301 that meet the requirements.

### Embodiment 3

FIG. 8 is a schematic diagram of the assembly of the experimental area provided in another embodiment, which is the same as the experimental area provided in the embodiment shown in FIG. 7, and the laboratory is also composed of three laboratory units (Unit A, Unit B and Unit C).) are spliced together, the arrow in the figure is the direction of the experimenter entering the experimental area. Specifically, unit A includes a first area A101 and a second area A102, unit B includes a first area B201 and a second area B202, and unit C includes a first area C301 and a second area C302. During splicing, the broad side of the second area A102 of the A unit is adjacent to the broad side of the second area B202 of the B unit, and the broad side of the first area A101 of the A unit is adjacent to the long side of the first area B201 of the B unit, the broad side of the first area B201 of the B unit is adjacent to the broad side of the first area C301 of the C unit and the long side of the second area C302 of the C unit, and the broad side of the second area C302 of the C unit is adjacent to the first area of the C unit. The long sides of an area C301 are adjacent to each other. However, unlike the experimental area shown in FIG. 7, in the embodiment shown in FIG. 8, not every area needs to be separated by a partition. Between the two areas C302, between the first area C301 of the C unit and the first area B201 of the B unit, and between the second area C302 of the C unit and the first area B201 of the B unit, there are partitions, so that the C The second area C302 of the unit forms an independent gas environment and serves as an experimental operating room. However, between the first area A101 of the A unit and the first area B201 of the B unit, and between the second area A102 of the A unit and the second area B202 of the B unit, no separator is provided. The first area A101 of the unit and the first area B201 of the B unit are connected into one area, and by adjusting the dampers in the first area A101 of the A unit and the first area B201 of the B unit respectively, the first area A101 and the first area B201 of the B unit are adjusted. The first area B201 has the same gas environment (e.g., equal pressure conditions), so that a larger experimental operation room can be formed, that is, the first area A101 and the first area B201 are jointly used as an experimental operation room. Similarly, the second area A102 of the A unit and the second area B202 of the B unit are also communicated into one area. By adjusting the dampers in the second area A102 and the second area B202, the second area A102 and the second area B202 has the same gas environment, which together form a buffer chamber. A partition is provided between the buffer chamber formed by the second area A102 and the second area B202 and the experimental operation room formed by the first area A101 and the first area B201 to isolate the buffer room from the experimental operation room. In this way, it is realized that the experimenter can perform different experiments in two different experimental operating rooms that meet the requirements.

Optionally, each laboratory unit 10 may further include an air supply branch duct 4 and an air exhaust branch duct 5. Specifically, the first air supply connection duct 15 and the second air supply connection duct 25 are both connected to the air supply branch duct 4, and are connected to the air supply main duct through the air supply branch duct 4; Both of the two exhaust air connection pipes 26 are connected to the exhaust branch pipe 5, and are connected to the exhaust main pipe through the exhaust branch pipe 5. That is, the air supply branch pipes 4 are respectively connected with the first air supply connection pipe 15, the second air supply connection pipe 25 and the main air supply pipe; the air exhaust branch pipes 5 are respectively connected with the first air exhaust connection pipe 16, the second air exhaust connection pipe The connecting duct 26 is connected to the exhaust main duct. Optionally, a recooling coil and/or a reheating coil 3 may be provided on the air supply branch pipe 4 to adjust the temperature of the gas in the air supply branch pipe.

In a specific implementation, the first air supply connection duct 15, the first exhaust air connection duct 16, the second air supply connection duct 25, the second exhaust air connection duct 26, the air supply branch duct 4 and the exhaust branch duct 5 can be provided In the interlayer at the upper part of the ceiling of the laboratory unit 10, it can avoid occupying the experimental space. Optionally, each laboratory unit 10 is provided with only one air supply branch duct 4 and one air exhaust branch duct 5, that is, the first area 1 and the second area 2 in the laboratory unit 10 share one air branch duct 4 and one air branch duct 4. Exhaust branch pipe 5.

Optionally, the ratio of the fresh air volume in the first area 1 to the volume of the first area 1 is greater than or equal to 12, and the ratio of the fresh air volume in the second area 2 to the volume of the second area 2 is greater than or equal to 12.

Specifically, the ratio of the new air intake volume Q in a certain area to the volume V of the area is the ventilation frequency AC in the area. When the shape of the area is approximately a rectangular parallelepiped, the volume V is further equal to the area S of the area and the volume of the area. The product of the height H of the area, and the area S of the area can be expressed as the product of the length L and the width W of the area. Therefore, when the area is approximately a cuboid, the number of changes satisfies:

Because the operator's breathing or doing experiments will make the gas in the laboratory turbid or even suspended with particulate matter that is harmful to the human body, there are certain requirements for the gas environment in the laboratory. Taking into account the setting requirements of laboratory temperature, humidity and gas pressure, in the present invention, the number of air changes in the first area and the second area is set to at least 12 times, so as to ensure that the temperature, humidity and pressure in each area conform to the experimental environment. requirements and without discomfort to the experimenter.

Therefore, the air supply valve and the air exhaust valve can be adjusted according to the length, width and height of the first area and/or the second area and the number of air changes required by the area to control the fresh air volume to reach the required range.

In the specific implementation, if the wind speed in the pipeline is too high, it will cause a lot of noise and make the personnel in the laboratory feel uncomfortable. If the customs in the pipeline are too small, it will increase the cost of the air duct and take up too much installation space. Taking the above factors into consideration, optionally, in this application, the wind speed in each pipeline is set to 3 to 5 m/s, that is, the first air supply connection pipeline 15, the first exhaust air connection pipeline 16, and the second air supply connection pipeline 25, The wind speed in the second air exhaust connection duct 26, the air supply branch duct 4 and the air exhaust branch duct 5 are all set to 3-5 m/s.

Optionally, the air duct connected to the air valve needs to have a certain straight air duct, in order to avoid the turbulent flow of the gas in the pipe at the bend caused by the turning of the air duct, thereby affecting the control accuracy of the valve. Therefore, in the present application, the first air supply connection pipe 15 may include a first air supply inlet straight pipe connected to the inlet end of the first air supply valve 11 and a first air supply outlet straight pipe connected to the outlet end of the first air supply valve 11. Pipe; the first exhaust air connection pipe 16 may include a first exhaust air inlet straight pipe connected to the inlet end of the first exhaust valve 14 and a first exhaust air outlet straight pipe connected to the outlet end of the first exhaust valve 14. The second air supply connection pipe 25 may include a second air supply inlet straight pipe connected to the inlet end of the second air supply valve 21 and a second air supply outlet straight pipe connected to the outlet end of the second air supply valve 21; the second air exhaust connection The duct 26 may include a second exhaust air inlet straight duct connected to the inlet end of the second air exhaust valve 23 and a second exhaust air outlet straight duct connected to the outlet end of the second air exhaust valve 23.

Further, in order to ensure the accuracy of the valve control to better realize the adjustment of the pressure (positive or negative pressure) in the first area, so as to achieve the expected control pressure and air volume requirements, the diameter of the straight pipe of the first air supply inlet can be Set to 1.5 times the width of the first air supply valve 11, the diameter of the first air outlet straight pipe can be set to 0.5 times the width of the first air supply valve 11; the diameter of the first exhaust air inlet straight pipe can be the first row The width of the air valve 14 is 1.5 times, and the diameter of the straight pipe of the first exhaust air outlet may be 0.5 times the width of the first air exhaust valve 14.

Similarly, in order to better adjust the pressure (positive pressure or negative pressure) in the second area, the diameter of the second air inlet straight pipe is 1.5 times the width of the second air valve 21, and the diameter of the second air outlet straight pipe The diameter is 0.5 times the width of the second air supply valve 21. The diameter of the second exhaust air inlet straight pipe is 1.5 times the width of the second exhaust valve 23, and the diameter of the second exhaust air outlet straight pipe is 0.5 times the width of the second exhaust valve 23.

Those skilled in the art can understand that the inlet end and the outlet end of each damper can be defined according to the flow direction of the gas in the valve. For the air supply valve, its inlet end is the end where the gas flows in (in this application, the end close to the air supply branch pipe 4), and the outlet end of the air supply valve is the end where the gas flows out (in this application, the end close to the air supply branch pipe 4) for the end close to the air outlet). Similarly, the inlet end of the exhaust valve is the end where the gas flows in (in this application, the end close to the exhaust port), and the outlet end of the exhaust valve is the end where the gas flows out (in this application, the end close to the exhaust branch pipe) 5 at one end).

Optionally, in order to ensure that each damper in the laboratory can be installed and performed safely, the distance between each damper is set to at least 0.5 meters.

Optionally, the first air supply valve 11 and/or the second air supply valve 21 may be a constant air volume valve (Constant Air Volume, CAV), and the first air exhaust valve 14 and/or the second air exhaust valve 23 may be a variable air volume valve. Air volume valve (Variable Air Volume, VAV).

Specifically, the control of the air volume by the constant air volume valve does not require external power, and the position of the control valve can be positioned by relying on the air force in the air duct, so as to maintain the air flow at the preset flow rate in the entire pressure condition range, which has controllable Features of high precision. The variable air volume valve adapts to the change of load by adjusting the air volume sent into the room. At the same time, when determining the total air volume of the system, certain simultaneous usage conditions can be considered, so it can save the energy consumption of the fan and reduce the installed capacity of the fan. Therefore, in the present application, the air inlet valve adopts a constant air volume valve, and the air exhaust valve adopts a variable air volume valve design, which can take into account the two-way advantages of control accuracy and energy saving.

Optionally, the area of the first area 1 is 10 m² to 20 m², and the area of the second area 2 is 2 m² to 9 m². This setting can effectively improve the utilization rate of the laboratory. When the customer needs experimental areas of different areas, it is more convenient and space-saving to splicing multiple laboratory units, and it can also ensure that each mechanism in the laboratory unit (such as The smooth operation of the exhaust valve and the air supply valve) to better regulate the gas environment in the experimental area. Further, the length of the first area 1 is not less than 3 m, and the width of the first area 1 is not less than 2.5 m; the length of the second area 2 is 1.5 m-3 m, and the width of the first area 2 is 1.5 m-3 m.

Specifically, the length of the first area 1 may be 5.05 m, the width is 3.3 m, and the height is 2.84 m; the length of the second area 2 may be 2.95 m, the width is 3.3 m, and the height is 2.84 m. This design facilitates the splicing and assembly of multiple laboratory units.

Optionally, the first area 1 is an experimental operation room, and the second area 2 is a buffer room. In a specific implementation, the second area 2 can be set between the first area 1 and the external environment of the laboratory unit, so as to isolate the second area serving as the experimental operating room and the external environment, and prevent the influence of the external environment on the experimental operating room.

The laboratory provided by the present invention includes a plurality of laboratory units, and one or more of the laboratory units 10 can be assembled to form a new experimental area to meet the individual needs of customers. Since each laboratory unit 10 can be subdivided into a first area 1 and a second area 2, and each first area 1 and second area 2 are independently provided with air supply valves and air exhaust valves, according to each, the gas environment required by the area adjusts the exhaust valve and air supply valve in the area to control the air intake and exhaust air volume of each area, so that each laboratory unit can reach the required pressure conditions and other gases environmental requirements. In addition, each laboratory unit 10 is connected to the main air intake pipe and the main exhaust air pipe respectively through pipes, that is, it is not necessary to install an air conditioning system in each laboratory unit 10, and each laboratory unit 10 only needs to be connected to the same When the general air-conditioning system is connected, the gas replacement in each laboratory unit 10 can be realized, the construction cost of the laboratory can be saved, and the energy waste can be reduced.

Although the present invention has been illustrated and described by referring to some preferred embodiments of the present invention, those of ordinary skill in the art should understand that the above content is an optional detailed description of the present invention in combination with specific embodiments, and cannot be It is intended that embodiments of the present invention be limited only by these descriptions. Those skilled in the art may make various changes in form and details, including making several simple deductions or substitutions, without departing from the spirit and scope of the present invention.

1. A laboratory, comprising:
a plurality of laboratory units, each of which includes a first area and a second area;
wherein the first area includes the first air supply connection pipe has one end connected to the main air supply pipe, and the other end forms a first air supply port that communicates with the gas environment of the first area, the first air supply connection pipe provided with a first air supply valve;
the first air exhaust connection pipe has one end connected to the exhaust air main pipe, and the other end forms a first air exhaust port that communicates with the gas environment of the first area, the first exhaust air connection pipe provided with a first row damper;
the second area includes the second air supply connection pipe has one end communicated with the air supply main pipe, and the other end forms a second air supply port that communicates with the gas environment in the second area, the second air supply connection pipe provided with a second air supply port air valve;
the second air exhaust connection pipe having one end connected to the exhaust air main pipe, and the other end forming a second air exhaust port that communicates with the gas environment of the second area, and the second air exhaust connection pipe is provided with a second air outlet second exhaust valve.

2. The laboratory of claim 1, further comprising a plurality of experimental areas, each of which is formed by splicing at least one of the laboratory units.

3. The laboratory of claim 1, wherein each of the laboratory units further comprises an air supply branch pipe and an air exhaust branch pipe; wherein,
both the first air supply connection pipe and the second air supply connection pipe are connected with the air supply branch pipe, and are connected with the air supply main pipe through the air supply branch pipe, and the air supply branch pipe is connected with the air supply main pipe, and a recooling coil and/or a reheating coil are arranged on the upper part to adjust the temperature of the gas in the air supply branch pipe; and
the first air exhaust connection duct and the second air exhaust connection duct are both connected to the air exhaust branch duct, and are connected to the air exhaust main duct through the air exhaust branch duct.

4. The laboratory according to claim 1, wherein the ratio of the fresh air volume in the first area to the volume of the first area is greater than or equal to 12; the fresh air volume in the second area is equal to or greater than 12, and the volume ratio of the second region is greater than or equal to 12.

5. The laboratory of claim 3, wherein the first air supply connection pipe, the first exhaust air connection pipe, the second air supply connection pipe, the second exhaust air connection pipe, and a wind speed in the air supply branch pipe and the air exhaust branch pipe is 3-5 m/s.

6. The laboratory of claim 1, wherein,
the first air supply connection pipeline comprises a first air supply inlet straight pipeline connected to the inlet end of the first air supply valve and a first air supply outlet straight pipeline connected to the outlet end of the first air supply valve; wherein, the diameter of the first air inlet straight pipe is 1.5 times the width of the first air supply valve, and the diameter of the first air outlet straight pipe is 0.5 times the width of the first air supply valve; and
wherein the first exhaust connection pipe comprises a first exhaust inlet straight pipe connected to the inlet end of the first exhaust valve and a first exhaust outlet straight pipe connected to the outlet end of the first exhaust valve; wherein, the diameter of the first exhaust inlet straight pipe is 1.5 times the width of the first exhaust valve, and the diameter of the first exhaust outlet straight pipe is 0.5 times the width of the first exhaust valve.

7. The laboratory of claim 4, wherein the second air supply connection pipeline comprises a second air supply inlet straight pipeline connected to the inlet end of the second air supply valve and a second air supply outlet straight pipeline connected to the outlet end of the second air supply valve;
wherein, the diameter of the second air inlet straight pipe is 1.5 times the width of the second air supply valve, and the diameter of the second air outlet straight pipe is 0.5 times the width of the second air supply valve; and
the second exhaust air connection pipe comprises a second exhaust air inlet straight pipe connected to the inlet end of the second air exhaust valve and a second exhaust air outlet straight pipe connected to the outlet end of the second air exhaust valve;
wherein the diameter of the second exhaust inlet straight pipe is 1.5 times the width of the second exhaust valve, and the diameter of the second exhaust outlet straight pipe is 0.5 times the width of the second exhaust valve.

8. The laboratory according to claim 1, wherein the distance between each adjacent damper is at least 0.5 meters.

9. The laboratory of claim 1, wherein the first air supply valve and/or the second air supply valve is a constant air volume valve; and/or,
the first air exhaust valve and/or the second air exhaust valve are variable air volume valves.

10. The laboratory of claim 1, wherein the first area covers an area of 10 m² to 20 m², and the second area covers an area of 2 m² to 9 m².

11. The laboratory according to claim 10, wherein the length of the first area is greater than or equal to 3 m, the width of the first area is greater than or equal to 2.5 m; the length of the second area is 1.5 m to 3 m, and the width of the second region is 1.5 m to 3 m.

12. The laboratory of claim 10, wherein the first area is a laboratory operation room, and the second area is a buffer room.
